(19) United States
(12) Patent Application Publication
(10) Pub. No.: US 2007/0199240 A1
(43) Pub. Date: Aug. 30, 2007

(54) Protection device for bulbs, seeds and/or partially germinated plants

(76) Inventor: Juergen Koessler, Surrey (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/362,185

(22) Filed: Feb. 27, 2006

(51) Int. Cl. A01G 13/02

(52) U.S. Cl. 47/31.1

(57) ABSTRACT

A bulb protection device protects planted bulbs, seeds and/or partially germinated plants from being accessed by animals or inadvertently contacted by humans. The device comprises a generally horizontally extending base perforated by one or more aperture(s), a downwardly extending peripheral flange around a peripheral edge of the base, and a plurality of stakes. The peripheral flange may also have portions that extend further downwardly at spaced apart locations. After a bulb has been planted in the ground, the device is placed on the ground surface above the bulb and driven into the ground. The stakes and/or the further-downwardly-extending portions of the peripheral flange secure the device to the ground. The base, the stakes, and the peripheral flange protect the planted bulb from contact by animals or inadvertent contact by humans. The bulb's stalk is permitted to grow through the one or more apertures in the base. The device may also incorporate a repellent chemical as an additional deterrent against animals.

### TECHNICAL FIELD

The present invention relates to protecting bulbs, seeds and/or partially germinated plants which have been planted in the ground or in other suitable material. Particular embodiments provide devices for protecting planted bulbs, seeds and/or partially germinated plants from damage by animals.

### BACKGROUND

Many people plant flower bulbs in their outdoor gardens and/or flower pots in hope that the flower bulbs will grow into flowers which add aesthetic appeal to their homes and yards. However, some animals, such as squirrels and other rodents, have a tendency to dig up these planted flower bulbs and to eat them or otherwise damage the bulbs. There is a general need to protect planted bulbs and/or seeds from damage by animals.

In addition, people may accidentally uncover or otherwise damage planted bulbs and/or seeds when they are gardening, using garden tools or the like. There is also a need to protect planted bulbs and/or seeds from inadvertent damage caused by humans.

U.S. Pat. No. 6,067,752 (Bryan et al.) discloses a device for protecting bulbs and roots from burrowing animals. The Bryan et al. device comprises a permanently installed protection cage which encloses a volume and is open at the top edge. The protection cage is placed in the soil up to the top edge, bulbs or rooted plants are placed within an interior volume of the protection cage and the protection cage is filled with soil. As the plant begins to grow, the plant's roots penetrate the mesh of the protection cage. This protection device requires that the bulb be installed in the cage prior to planting which can be messy and can make it difficult to optimize the placement of the bulb. In addition, the Bryan et al. cage is permanently installed and is incapable of being reused without damaging the plant.

There remains a need for ways to protect planted bulbs, seeds and/or partially germinated plants from damage by animals and from inadvertent damage caused by humans.

### SUMMARY

A first aspect of this invention provides a device for protecting a bulb which is planted in a material below a surface thereof. The device comprises a base positionable overtop of the planted bulb to extend horizontally from one side of the planted bulb to an opposing side of the planted bulb for protecting the planted bulb against contact from above. The base is perforated by one or more apertures. The device also comprises a flange which extends downwardly from the base and at least partially around a center of the base. The flange is insertable into the material to project downwardly therein for protecting the planted bulb against contact from the side.

A second aspect of the invention provides a method for protecting a planted bulb. The method involves: planting a bulb in a material below a surface thereof; providing a protective device comprising a base perforated by one or more apertures and a peripheral flange which extends downwardly from, and at least partially around a center of, the base; positioning the base over top of the planted bulb such that the base extends horizontally from one side of the planted bulb to an opposing side of the planted bulb to protect the planted bulb against contact from above; and pressing the flange downwardly into the material to protect the planted bulb against contact from the side.

Another aspect of the invention provides a device for protecting a bulb which is planted in a material below a surface thereof. The device comprises a base positionable overtop of the planted bulb to extend horizontally from one side of the planted bulb to the opposing side of the planted bulb for protecting the planted bulb against contact from above. The base may be perforated by one or more apertures not exceeding 400 mm². The device also comprises a flange which extends downwardly from the base and around a center of the base at a location spaced apart therefrom. The flange may be insertable into the material to project downwardly therein by an amount greater than or equal to 25 mm for protecting the planted bulb against contact from the side.

### BRIEF DESCRIPTION OF DRAWINGS

In drawings which show non-limiting embodiments of the invention:

FIG. 1 is a perspective view of a bulb protection device according to a particular embodiment of the invention;

FIG. 2 is a top plan view of the FIG. 1 device;

FIG. 3 is a cross-sectional side view of the FIG. 1 device taken along line 3-3 of FIG. 2;

FIG. 4 is a cross-sectional view of one of the stakes of the FIG. 1 device taken along the line 4-4 of FIG. 3;

FIG. 5 is a perspective view of a bulb protection device according to a second embodiment of the invention;

FIG. 6 is a cross-sectional side view of the FIG. 5 device;

FIG. 7 is a perspective view of a bulb protection device according to a third embodiment of the invention;

FIGS. 8A and 8B are partial cross-sectional views of the FIG. 1 device in use for protecting a planted bulb;

FIGS. 9A and 9B are partial cross-sectional views of a bulb protection device according to another embodiment of the invention in use for protecting a planted bulb;

FIGS. 10A and 10B are side views of detachable stakes according to other embodiments of the invention;

FIG. 11A is a perspective view of a convex base of a bulb protection device according to another embodiment of the invention;

FIG. 11B is a side view of a detachable stake suitable for use with the FIG. 11A base;

FIG. 11C is a cross-sectional side view of a bulb protection device incorporating the FIG. 11A base and the FIG. 11B stakes.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Aspects of the invention provide devices for protecting bulbs, seeds and/or partially germinated plants. Particular embodiments of the invention provide a base penetrated by a plurality of apertures. The apertures are sized to prevent access by animals to the planted bulb. Preferably, the base is sufficiently wide (i.e. in a generally horizontal dimension) to protect a planted bulb. The base may have a flange or some other type of barrier that extends downwardly into the material in which the bulb is planted to protect against, or at least discourage, digging animals. In some embodiments, the base is generally flat and in other embodiments, the base may be convex.

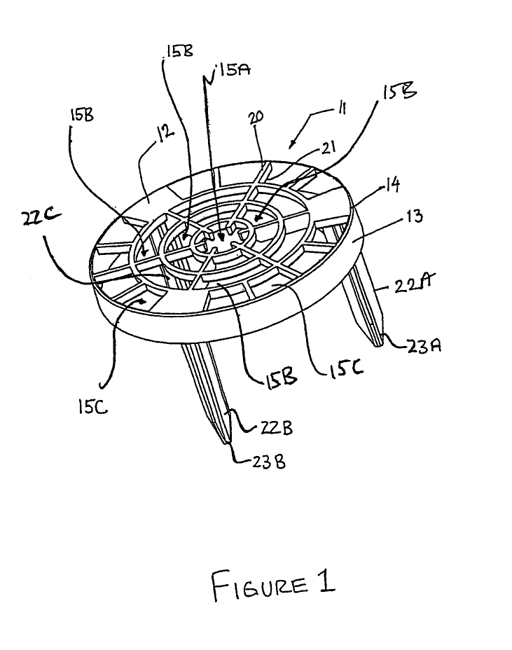

FIGS. 1-4, 8A and 8B show a bulb protection device 11 according to a particular embodiment of the invention. Bulb protection device 11 comprises a generally horizontally-extending, perforated base 12 having a top side 20, a bottom side 21 and a peripheral edge 14. Base 12 of bulb protection device 11 has a generally planar profile and a circular peripheral edge 14. In general, however, base 12 may have other profiles (such as a convex or concave profile, for example) and may have a peripheral edge 14 having some other shape (such as a polygonal shape, an oval shape or an elliptical shape, for example). Base 12 is perforated by a central aperture 15A, a plurality of intermediate apertures 15B and a plurality of exterior apertures 15C (collectively, apertures 15). Device 11 comprises a flange 13 which extends downwardly from peripheral edge 14 or from some other region of base 12. Downwardly-extending flange 13 of device 11 extends around the entirety of peripheral edge 14, although this is not strictly necessary. Device 11 also comprises a plurality of stakes 22A, 22B, 22C (collectively, stakes 22) which extend downwardly from base 12 at spaced-apart locations.

Device 11 may be made of plastic. In some embodiments, device 11 comprises a single piece of injection molded plastic. Plastic is advantageous because it is relatively inexpensive, resistant to corrosion, and is less likely to cause accidental harm to people. In other embodiments, however, device 11 (or parts of device 11) are made from different materials such as metal, rubber, ceramic or the like. In some embodiments, device 11 is fabricated from a number of component parts which are connected together to form device 11. For example, stakes 22 may be fabricated separately from base 12 and may be coupled to base 12 using some suitable coupling technique to form device 11. In some embodiments, stakes 22 and base 12 are formed separately from plastic and are capable of being coupled to one another using deformable “snap-together” connections. Fabricating device 11 in a number of parts may be advantageous for shipping or storage, because the component parts of device 11 may occupy less volume when they are disassembled.

As shown best in FIG. 2, the apertures 15 which perforate base 12 of device 11 are defined by the intersection of a plurality of concentric strips 17A-17C (collectively, concentric strips 17) and a plurality of radially extending strips 16A-16F (collectively, radially extending strips 16) which form a grid pattern. Concentric strips 17 of device 11 are circularly-shaped and extend around a center of base 12. In other embodiments, where peripheral edge 14 has a shape other than circular, concentric strips 17 may have the same general shape as peripheral edge 14. In some embodiments, strips 17 are not concentric. In embodiments where peripheral edge 14 has a shape other than circular, radially extending strips 16 need not extend in strictly radial directions, but may generally extend away from a center of base 12. In the illustrated embodiment, radially extending strips 16A-16F extend radially inwardly past innermost circular strip 17C and project into central aperture 15A to form tongue portions 19A-19F (collectively, tongue portions 19).

In the illustrated embodiment, base 12 has solid portions (i.e. portions without apertures) 18A, 18B, 18C (collectively, solid portions 18) in the locations corresponding to the locations of stakes 22. Solid portions 18 strengthen base 12 in the locations of stakes 22 and, in some embodiments, where stakes 22 are fabricated separately from base 12, solid portions 18 can assist with coupling stakes 22 to base 12 by supporting or providing fastening mechanisms or the like.

In some embodiments, base 12 has a diameter (on a horizontal plane) in a range of 5-20 cm. In some embodiments, base 12 has a cross-sectional area (on a horizontal plane) in range of 19-400 cm². The sizes and shapes of strips 16, 17 and solid portions 18 may be varied to provide grid patterns with different aperture shapes and patterns. Preferably, apertures 15 are sufficiently small to prevent small animals, such as squirrels and other rodents for example, from reaching through base 12. Preferably apertures 15 are smaller than the bulbs that they are designed to protect. In some embodiments, apertures 15 have cross-sectional areas not exceeding 400 mm². In other embodiments, apertures 15 have cross-sectional areas not exceeding 225 mm². Preferably, strips 16, 17 and solid portions 18 are sized such that the area of base 12 covered by apertures 15 is greater than the non-apertured area of base 12 (i.e. strips 16, 17 and solid portions 18). In some embodiments, the ratio of the total apertured area of base 12 to the total non-apertured area of base 12 is greater than 3:2. In other embodiments the ratio of the total apertured area of base 12 to the total non-apertured area of base 12 is greater than 2:1.

Downwardly-extending flange 13 of device 11 extends downwardly from peripheral edge 14 (or some other region of base 12) to help secure device 11 in the ground 32 and to help protect a planted bulb from digging animals or to at least discourage animals from digging under device 11. In some embodiments, downwardly-extending flange 13 extends downwardly from base 12 by an amount that is greater than twice the thickness of base 12 (i.e. the dimension of base 12 from top side 20 to bottom side 21). In other embodiments, downwardly-extending flange 13 extends downwardly from base 12 by an amount that is greater than three times the thickness of base 12. In some embodiments, downwardly-extending flange 13 extends downwardly from base 12 by an amount greater than 25 mm. In some embodiments, downwardly-extending flange 13 extends downwardly from base 12 by an amount greater than 40 mm. Once downwardly-extending flange 13 is driven into the ground 32, the downward and peripheral extension of downwardly-extending flange 13 helps to secure device 11 in the ground 32 and to prevent horizontal movement of device 11. Downwardly-extending flange 13 also helps to protect planted bulbs by preventing digging animals from accessing the bulbs from the side or from underneath base 12.

In the illustrated embodiment of FIGS. 1-4, 8A and 8B, downwardly-extending flange 13 extends around substantially an entirety of peripheral edge 14. This is not strictly necessary. In some embodiments, downwardly-extending flange 13 extends downwardly from some other region of base 12 and extends completely around a center of base 12. In other embodiments, downwardly-extending flange 13 comprises one or more flange components, each or which extends downwardly but only partially around peripheral edge 14 or only partially around a center of base 12. In some embodiments, each flange component extends around 10% or more of peripheral edge 14 or some other circular or non-circular circumference of the center of base 12. In some embodiments, each flange component extends around 20% or more of peripheral edge 14 or some other circular or non-circular circumference of the center of base 12. Preferably, the spaces between flange components is sufficiently small that animals are unable to reach between the spaces in the flange components to access a bulb. In some embodiments, the spaces between the flange components are less than 10 mm wide. In other embodiments, the spaces between the flange components are less than 25 mm wide.

In some embodiments, a ratio of a total amount of peripheral edge 14 (or some other circular or non-circular circumference of the center of base 12) having downwardly-extending flange 13 (or flange components) to a total amount of peripheral edge 14 (or some other circular or non-circular circumference of the center of base 12) not having downwardly-extending flange 13 (or flange components) is at least 1:4. In other embodiments, this ratio is at least 1:2.

Stakes 22 may be driven into the ground 32 to further help secure bulb protection device 11 in a particular location. As shown best in FIGS. 1 and 3, stakes 22 may comprise pointed ends 23A, 23B, 23C (collectively, ends 23) which allow stakes 22 to be easily driven into the ground 32. In the illustrated embodiment, device 11 comprises three stakes 22 located at spaced apart locations. In general, device 11 may comprise any suitable number of stakes 22. Preferably, however, the number of stakes 22 is two or greater to minimize the chance that device 11 will rotate once it is secured in the ground 32. In the illustrated embodiment, stakes 22 are located at spaced-apart locations just interior to the peripheral edge 14 of base 12. Such placement is not necessary. In general, stakes 22 may be located anywhere on base 12.

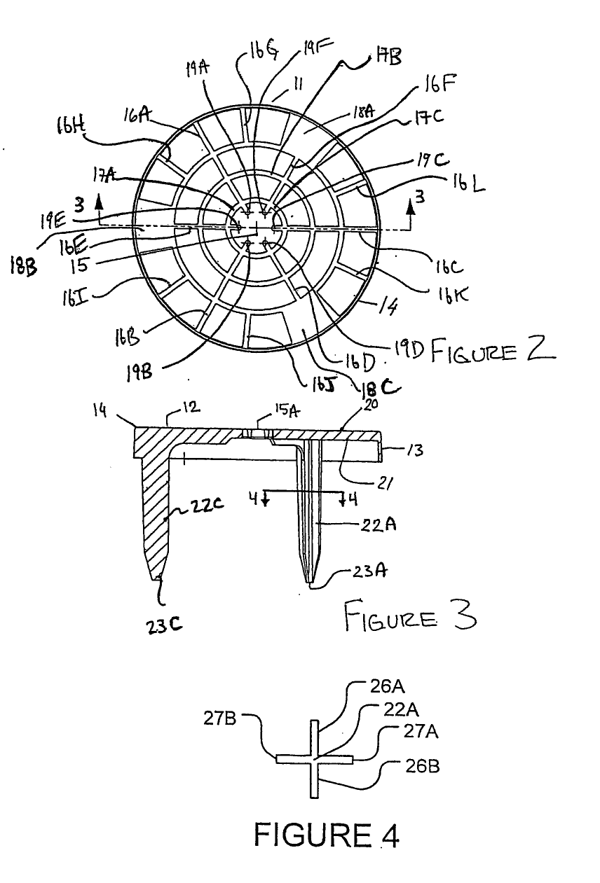

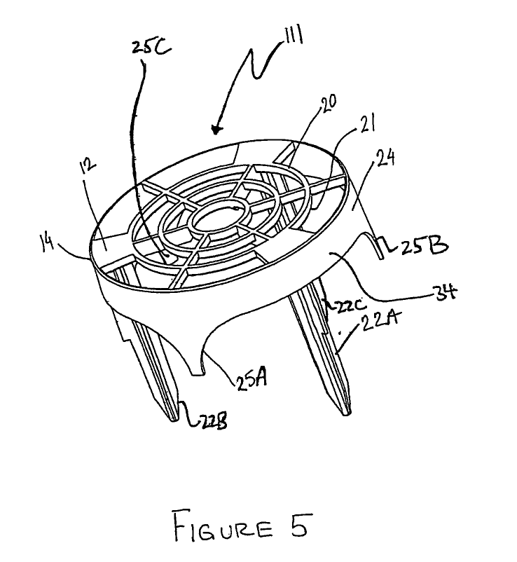

FIG. 4 depicts a cross-sectional view of stake 22A along the line 4-4 of FIG. 3. Stake 22A is generally cross-shaped in cross-section and comprises a plurality of outwardly extending flanges 26A, 26B, 27A, 27B. The “multiple-flange” shape of stake 22A provides minimum resistance when driving stake 22A vertically into the ground 32. Once stake 22A is driven into the ground 32, however, flanges 26A, 26B, 27A, 27B provide resistance to any horizontal movement of stake 22A through the ground 32 and rotational movement of stake 22A about its elongated axis. The other stakes 22B, 22C of device 11 are substantially similar in cross-section to stake 22A and may exhibit similar features to those of stake 22A. While stakes 22 are preferably cross-shaped in cross-section, this is not necessary. Stakes 22 may have other cross-sectional shapes including circular cross-sectional shapes, polygonal cross-sectional shapes, oval or eliptical cross-sectional shapes, other “multiple-flange” cross-sectional shapes (e.g. Y-shapes, X-shapes, T-shapes, V-shapes) or the like.

In the illustrated embodiment of FIGS. 1-4, 8A and 8B, stakes 22 are formed integrally with base 12. In other embodiments, stakes 22 are formed separately from base 12 and are coupled to base 12 using any suitable fastening mechanism. Non-limiting examples of suitable fastening mechanisms include threaded fasteners, deformable “snap-together” fasteners, staples and the like.

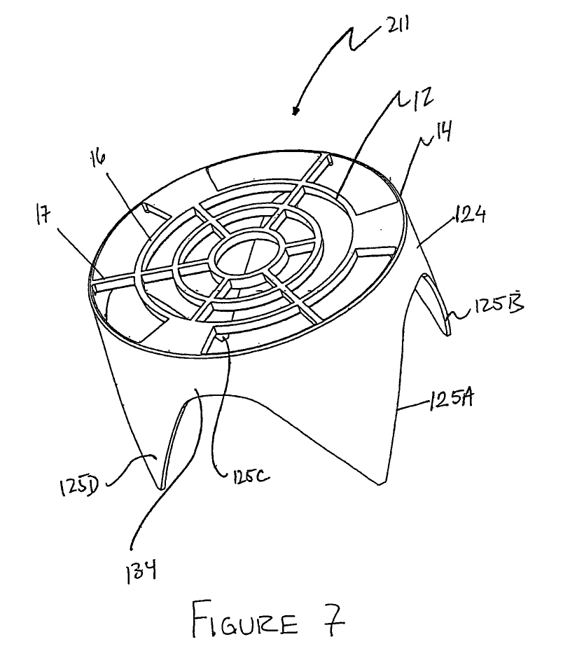

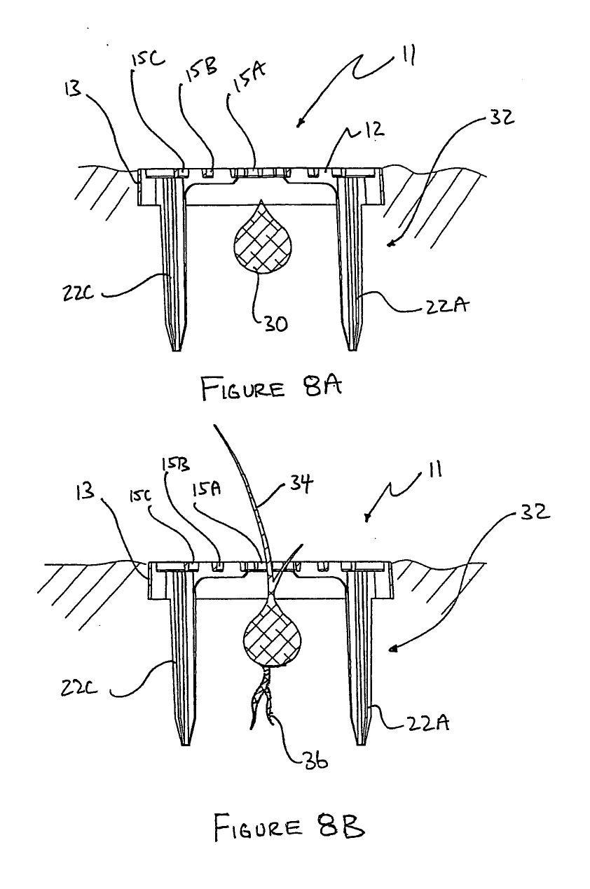

The operation of bulb protection device 11 to protect a planted bulb is now described with reference to FIGS. 8A and 8B. As shown in FIG. 8A, a bulb 30 (or a seed or a partially germinated young plant) is planted by burying bulb 30 in the ground 32. Once bulb 30 is planted, device 11 is positioned above the buried bulb 30 such that central aperture 15A is generally aligned vertically with bulb 30. Device 11 is then driven into the ground 32 until base 12 is approximately flush with, or slightly below, the level of the ground 32. A person may drive device 11 into ground 32 using their hands, their feet or a suitable tool. When device 11 is driven into the ground 32, stakes 22 and downwardly-extending flange 13 extend downwardly into the ground 32.

Once device 11 is installed in this manner, base 12, stakes 22 and downwardly-extending flange 13 cooperate to protect planted bulb 30 from being accessed by animals or damaged by accidental physical contact. More particularly, base 12 protects bulb 30 from above and downwardly-extending flange 13 and stakes 22 act to protect bulb 30 from the sides (e.g. against digging animals). In addition, stakes 22 and downwardly-extending flange 13 cooperate to prevent device 11 from being moved in a horizontal direction. More particularly, the multiple-flange shape of stakes 22 resist movement in any horizontal direction. Also, flange 13 helps to prevent horizontal movement of device 11 in horizontal directions. In the illustrated embodiment of FIGS. 1-4, 8A and 8B, downwardly-extending flange 13 extends around an entirety of peripheral edge 14 of base 12 and therefore helps to prevent horizontal movement of base 12 in all directions. In embodiments, where downwardly-extending flange 13 comprises a number of spaced-apart flange components, such flange components preferably extend around a substantial portion of peripheral edge 14 (or some other circular or non-circular circumference of the center of base 12), so that each flange component helps to help prevent horizontal movement in a number of directions. In other embodiments, the flange components are provided at closely spaced intervals around peripheral edge 14 (or some other circular or non-circular circumference of the center of base 12) to help prevent horizontal movement in a number of directions.

Bulb 30 may be watered through apertures 15 in base 12. As shown in FIG. 8B, once bulb 30 germinates, the bulb's stalk 34 may grow through any of the apertures 15 in base 12 and the bulb's roots 36 may grow freely in a generally downward direction. Preferably, device 11 is positioned such that stalk 34 grows through central aperture 15A. Once bulb 30 becomes a seedling (i.e. has grown to a sufficient degree (FIG. 8B)), device 11 may be removed from the ground 32 and stalk 34 may be withdrawn from the aperture 15 through which it has grown, so that device 11 may be reused for another bulb.

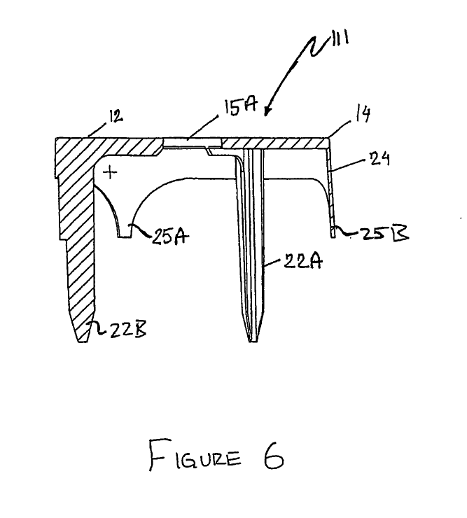

FIGS. 5 and 6 depict a bulb protection device 111 according to another embodiment of the invention. Bulb protection device 111 is similar to bulb protection device 11, except that bulb protection device 111 comprises a downwardly-extending flange 24 which is different than downwardly-extending flange 13 of device 11. Downwardly-extending flange 24 of device 111 comprises a downwardly extending wall 34 which is similar to downwardly-extending flange 13 of device 11. Downwardly-extending flange 24 also comprises a plurality of further-downwardly-extending portions 25A, 25B, 25C (collectively, further-downwardly-extending portions 25). Further-downwardly-extending portions 25 extend further-downwardly from wall 34 at locations spaced-apart around the peripheral edge 14 of base 12 (or around some other circular or non-circular circumference of the center of base 12). In operation, when device 111 is driven into the ground 32, further-downwardly-extending portions 25 help to secure device 111 in the ground 32 and also provide further protection to the bulb against contact from the sides (e.g. by digging animals).

In the illustrated embodiment, device 111 comprises three further-downwardly-extending portions 25. In other embodiments, a different number of further-downwardly-extending portions 25 are provided. Preferably, further-downwardly-extending portions 25 are located between pairs of stakes 22, so that further-downwardly-extending portions 25 cooperate with stakes 22 to provide greater protection to the bulb against contact from the sides. In the illustrated embodiment, further-downwardly-extending portions 25 have a tapered shape which allows them to be easily driven into the ground 32. This shape is not necessary and further-downwardly-extending portions 25 may have any other suitable shape. In some embodiments, the ratio of the downward extension of the regions of flange 24 containing further-downwardly-extending portions 25 to the regions of flange 24 without further-downwardly-extending portions 25 is greater than 3:2. In some embodiments, this ratio is greater than 2:1. In other respects, downwardly-extending flange 24 of device 111 may have characteristics similar to those of downwardly-extending flange 13 of device 11. In some embodiments, downwardly-extending flange 24 and further-downwardly-extending portions 25 may be sufficient to secure device 111 into the ground 32 without the need for stakes 22, in which case, stakes 22 are not required.

FIG. 7 depicts a bulb protection device 211 according to yet another embodiment of the invention. In some respects, bulb protection device 211 is similar to bulb protection devices 11, 111 discussed above. However, device 211 differs from devices 11, 111 in that device 211 has no stakes. Downwardly-extending flange 124 of device 211 is shaped to secure device 211 into the ground 32 without using stakes 22. Downwardly-extending flange 124 is similar to downwardly-extending flange 24 of device 111 in that downwardly-extending flange 124 comprises a downwardly extending wall 134 and a plurality of further-downwardly-extending portions 125A, 125B, 125C, 125D (collectively, further-downwardly-extending portions 125). Further-downwardly-extending portions 125 extend further-downwardly from wall 134 at locations spaced apart around the peripheral edge 14 of base 12 (or around some other circular or non-circular circumference of the center of base 12). In operation, when device 211 is driven into the ground 32, further-downwardly-extending portions 125 function on their own to secure device 211 in the ground 32. Further-downwardly-extending portions 125 also protect the bulb against contact from the sides (e.g. by digging animals).

In the illustrated embodiment, device 211 comprises four further-downwardly-extending portions 125. In other embodiments, a different number of further-downwardly-extending portions are provided. In the illustrated embodiment, further-downwardly-extending portions 125 have a tapered shape which allows them to be easily driven into the ground 32. This shape is not necessary and further-downwardly-extending portions 125 may have any other suitable shape. In some embodiments, the ratio of the downward extension of the regions of flange 124 containing further-downwardly-extending portions 125 to the regions of flange 124 without further-downwardly-extending portions 125 is greater than 3:2. In some embodiments, this ratio is greater than 2:1. In other respects, downwardly-extending flange 124 of device 211 may have characteristics similar to those of downwardly-extending flange 13 of device 11 and downwardly-extending flange 24 of device 111.

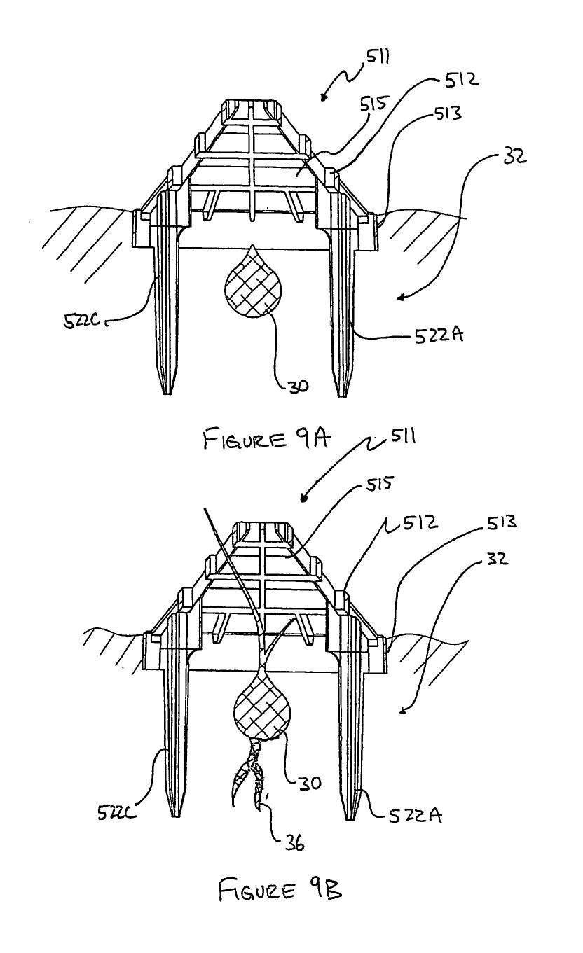

FIGS. 9A and 9B show cross-sectional views of a bulb protection device 511 according to yet another embodiment of the invention. In many respects, bulb protection device 511 is similar to bulb protection device 11 described above, except that base 512 is concave-shaped. Components of bulb protection device 511 that are similar to components of bulb protection device 11 are provided with similar reference numbers preceded by the numeral “5”. As shown in FIGS. 9A and 9B, when device 511 is installed in the ground 32, base 512 projects above the level of the ground 32. Convex-shaped base 512 can allow device 511 to be more easily seen and identified by humans and can facilitate planting bulb 30 relatively close to the level of ground 32 while still providing protection against animals. In some embodiments, base 512 is brightly colored to further alert humans of its presence. In other respects, bulb protection device 511 is similar to bulb protection device 11 described above.

Those skilled in the are will appreciate that bulb protection device 512 may be modified to provide downwardly-extending flanges having further-downwardly-extending portions similar to those of the bulb protection devices shown in FIGS. 5, 6 and 7.

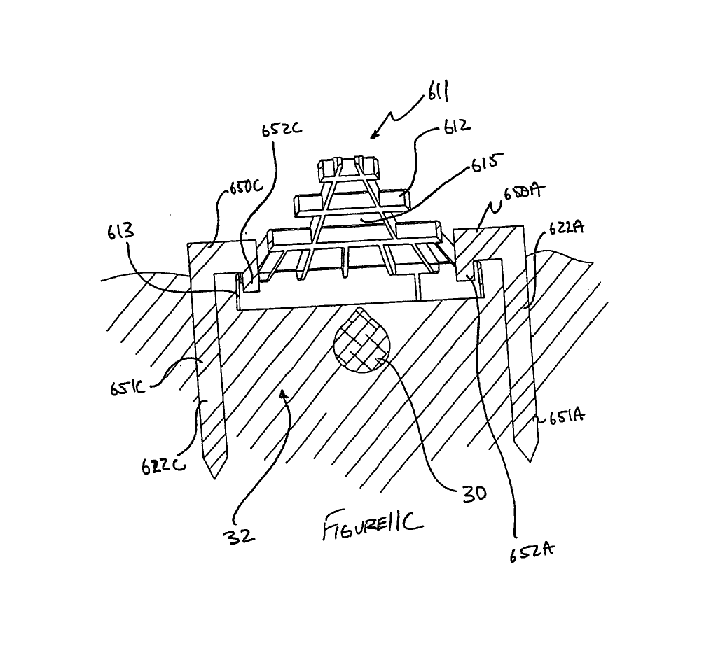

FIGS. 11A-11C show a bulb protection device 611 according to another embodiment of the invention. Bulb protection device 611 is similar in many respects to bulb protection device 511, except that stakes 622 are not formed integrally with base 612. Components of bulb protection device 611 that are similar to components of bulb protection device 611 are provided with similar reference numbers preceded by the numeral “6” rather than “5”. Convex base 612 is formed separately from stakes 622 and is shown in FIG. 11A. Convex base 612 is penetrated by apertures 615 and comprises a peripheral edge 614. A separately fabricated stake 622 is shown in FIG. 11B. Stake is generally L-shaped with a downwardly-extending stake body 651, a stake head 650 which extends away from stake body 651 at or near the top thereof, and a hook portion 652 which extends downwardly from head 650 in a location spaced-apart from stake body 651.

FIG. 11C shows bulb protection device 611 in use to protect a bulb 30. A pair of stakes 622A, 622C are visible in FIG. 11C. In the illustrated embodiment of FIG. 11C, stake bodies 650A, 650C of each stake 622A, 622C extend over downwardly-extending flange 613, such that stake bodies 651A, 651C extend into the ground 32 at locations outside of downwardly-extending flange 613 and such that hook portions 652A, 652C extend downwardly into apertures 615. In this manner, stakes 622A, 622C operate to help secure base 612 to the ground 32. In alternative embodiments, hook portions 652A, 652C extend downwardly at locations outside of downwardly-extending flange 613 and stake bodies 651A, 651C extend into the ground 32 through apertures 615. In still other alternative embodiments, both hook portions 652A, 652C and stake bodies 651A, 651C extend downwardly through apertures 615.

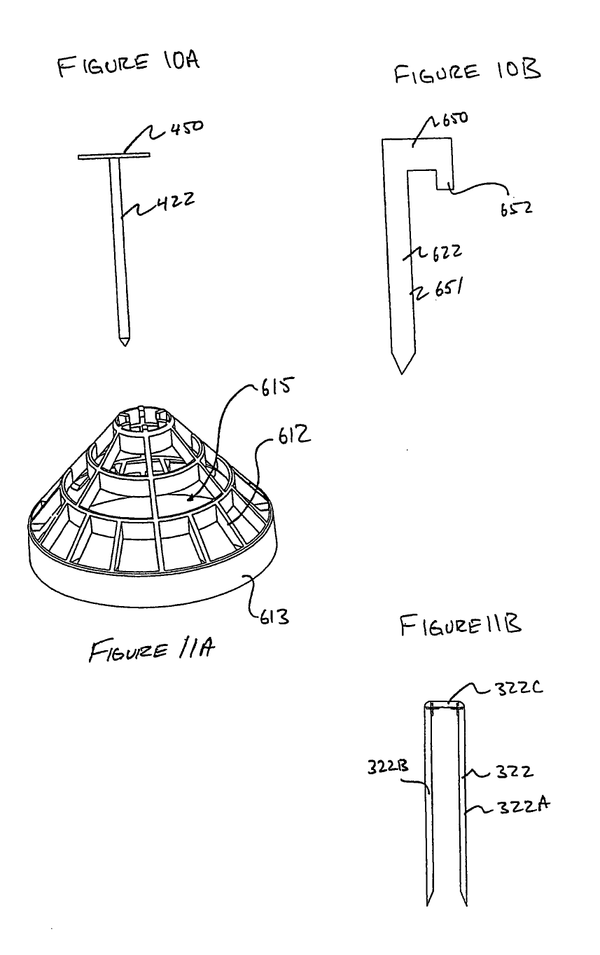

FIGS. 10A and 10B respectively show side views of detachable stakes 322 and 422 according to alternative embodiments of the invention. Stake 322 (FIG. 10A) is a U-shaped detachable stake that comprises a pair of legs 322A, 322B connected by a bridging portion 322C. Stake 322 may be driven into the ground 32 such that one (or both) of legs 322A, 322B extend(s) through an aperture in the base such that bridging portion 322C engages one or more the of the strips in the base to secure the base in the ground 32. Detachable stake 422 has a head 450 and may be driven into the ground 32 through an aperture in the base such that head 450 engages one or more of the strips in the base to secure the base in the ground 32.

As will be apparent to those skilled in the art in light of the foregoing disclosure, many alterations and modifications are possible in the practice of this invention without departing from the spirit or scope thereof. For example:
In the embodiments described above, the bulb protection devices are secured to the ground using stakes and/or their downwardly-extending flange. However, other mechanisms may additionally or alternatively be used to secure the bulb protection devices to the ground.
In some embodiments, the downwardly-extending flange (e.g. flange 13 of device 11 and the similar flanges described above) need not depend from a peripheral edge of the base and may extend downwardly from a location other than the periphery of the base.
In any of the embodiments disclosed above, a chemical animal repellent may be added to the device to provide further protection against animals. For example, during manufacture of the device, a repellent chemical may be added to the device. A chemical repellent may comprise a scent which irritates or otherwise repels animals which may dig up a bulb. Such a chemical repellent may be added to the device by spray coating the device for example. When the device is fabricated from plastic, such a repellent chemical may advantageously be added to the plastic resin from which the devices are formed such that the chemical will not wash off of the device by exposure to the elements. A non-limiting example of a repellent chemical is a chemical containing the scent of the urine of a predator animal.
In some embodiments, the bulb protection devices of the invention are brightly colored, so that they are highly visible and less likely to be damaged by inadvertence during gardening. These bright colors may correspond to the colors of the flowers that result from the planted bulbs so that people can ascertain what type of flower will grow from a corresponding planted bulb. In other embodiments, the bulb protection devices of the invention are neutrally colored, so that the devices blend with the soil and the foliage of the plants.
The bulbs are described above as being planted in the ground. In general, however, bulbs may be planted in soil or other materials and may be contained in pots or the like. The invention described herein should be understood to apply to protecting bulbs planted in any suitable material.
The devices described above are described as being useful for protecting bulbs. However, those skilled in the art will appreciate that these devices may be similarly used to protect seeds and/or partially germinated plants. Accordingly, the word “bulb” as used herein should be understood to incorporate seeds and partially germinated plants.
   Accordingly, the scope of the invention is to be construed in accordance with the substance defined by the following claims.

What is claimed is:

1. A device for protecting a bulb which is planted in a material below a surface thereof, the device comprising:
a base positionable overtop of the planted bulb to extend horizontally from one side of the planted bulb to an opposing side of the planted bulb for protecting the planted bulb against contact from above, the base perforated by one or more apertures; and
a flange which extends downwardly from the base and at least partially around a center of the base, the flange insertable into the material to project downwardly therein for protecting the planted bulb against contact from the side.

2. A device according to claim 1 comprising one or more elongated stakes which extend downwardly from the base, the stakes insertable into the material to project downwardly therein by an amount greater than the flange for securing the device against movement in the material and for providing additional protection to the bulb against contact from the side.

3. A device according to claim 2 comprising a plurality of stakes at spaced apart locations.

4. A device according to claim 3 wherein each of the plurality of stakes comprises multiple flanges which extend along a generally vertically oriented dimension of the stake and which extend away from one another for helping to secure the device against movement in the material.

5. A device according to claim 1 wherein the base comprises a grid of intersecting strips which define a plurality of apertures.

6. A device according to claim 5 wherein the plurality of apertures comprises a central aperture concentric with the base.

7. A device according to claim 5 wherein the grid of intersecting strips comprises a first plurality of strips that extend around the center of the base and a second plurality of strips that extend away from the center of the base and intersect with the first plurality of strips.

8. A device according to claim 7 wherein the first plurality of strips are circularly shaped and the second plurality of strips extend radially away from the center of the base.

9. A device according to claim 3 wherein the device is fabricated from a single piece of plastic.

10. A device according to claim 1 wherein the device is fabricated from plastic and wherein the device comprises an animal repellent incorporated into the plastic during fabrication.

11. A device according to claim 1 wherein a lower edge of the flange comprises one or more further-downwardly-extending portions which extend further downwardly into the material than other portions of the flange.

12. A device according to claim 11 wherein the one or more further-downwardly-extending portions are narrower as they extend further away from the base.

13. A device according to claim 3 wherein a lower edge of the flange comprises one or more further-downwardly-extending portions which extend further downwardly into the material than other portions of the flange.

14. A device according to claim 13 wherein the one or more further-downwardly-extending portions are narrower as they extend further away from the base.

15. A device according to claim 13 wherein the base comprises a grid of intersecting strips which define a plurality of apertures.

16. A device according to claim 15 wherein the plurality of apertures comprises a central aperture concentric with the base.

17. A device according to claim 15 wherein the grid of intersecting strips comprises a first plurality of strips that extend around the center of the base and a second plurality of strips that extend away from the center of the base and intersect with the first plurality of strips.

18. A device according to claim 15 wherein the device comprises a repellent chemical for repelling animals.

19. A device according to claim 15 wherein the device is made from a single piece of plastic.

20. A device according to claim 15 wherein the device is fabricated from plastic and wherein the device comprises an animal repellent incorporated into the plastic during fabrication.

21. A device according to claim 20 wherein the animal repellent comprises a scent of predator urine.

22. A method for protecting a planted bulb, the method comprising:
planting a bulb in a material below a surface thereof;,
providing a protective device comprising a base perforated by one or more apertures and a peripheral flange which extends downwardly from, and at least partially around a center of, the base;
positioning the base over top of the planted bulb such that the base extends horizontally from one side of the planted bulb to an opposing side of the planted bulb to protect the planted bulb against contact from above; and
pressing the flange downwardly into the material to protect the planted bulb against contact from the side.

23. A device for protecting a bulb which is planted in a material below a surface thereof, the device comprising:
a base positionable overtop of the planted bulb to extend horizontally from one side of the planted bulb to the opposing side of the planted bulb for protecting the planted bulb against contact from above, the base perforated by one or more apertures not exceeding 400 mm²;
a flange which extends downwardly from the base and around a center of the base at a location spaced-apart therefrom, the flange insertable into the material to project downwardly therein by an amount greater than or equal to 25 mm for protecting the planted bulb against contact from the side.
